(19) United States
(12) Patent Application Publication
(10) Pub. No.: US 2020/0193197 A1
(43) Pub. Date: Jun. 18, 2020

(54) INFORMATION PROCESSING APPARATUS AND COMPUTER-READABLE STORAGE MEDIUM

(71) Applicant: HONDA MOTOR CO.,LTD., Tokyo (JP)

(72) Inventors: Yoshikazu MATSUO, Saitama (JP); Toshikatsu KURAMOCHI, Tokyo (JP); Yusuke OI, Tokyo (JP); Hiromi SATO, Saitama (JP)

(21) Appl. No.: 16/705,245

(22) Filed: Dec. 6, 2019

(30) Foreign Application Priority Data
Dec. 13, 2018 (JP) 2018-233802

(51) Int. Cl. G06K 9/00; G08G 1/16; B60W 40/09; G05D 1/02; G05D 1/00

(52) U.S. Cl. CPC G06K 9/00845; G06K 9/00302; G08G 1/162; B60W 2040/0872; G05D 1/0214; G05D 1/0061; B60W 40/09

(57) ABSTRACT

An information processing apparatus is provided, including: an emotion estimating unit configured to estimate an emotion of an occupant of a movable body based on an image of the occupant of the movable body captured by an image-capturing unit provided in the movable body; and an output control unit configured to perform control to output description information about a control operation performed by the movable body when the control operation performed by the movable body is a predetermined control operation and an emotion of the occupant estimated by the emotion estimating unit when the control operation is performed is surprise.

The contents of the following Japanese patent application are incorporated herein by reference: 2018-233802 filed in JP on Dec. 13, 2018

### BACKGROUND

### 1. Technical Field

The present invention relates to an information processing apparatus and a computer-readable storage medium.

### 2. Related Art

Control operations actively performed by the motor vehicle side are known, such as antilock brake systems and collision mitigation brake systems. (see Patent Document 1, for example).

Patent Document 1: Japanese Patent Application Publication No. 2017-200822

### SUMMARY

For a movable body that moves with occupants onboard, such as a motor vehicle, it is preferable to provide a technique for appropriately supporting the occupant in accordance with the situation in performing control operations by the movable body side.

### BRIEF DESCRIPTION OF THE DRAWINGS

FIG. 1 schematically shows an example of a vehicle 100 according to the present embodiment.

FIG. 2 schematically shows an example of configuration of the vehicle 100.

FIG. 3 schematically shows an example of functional configuration of an information processing apparatus 200.

FIG. 4 schematically shows an example of a process flow of the information processing apparatus 200.

FIG. 5 schematically shows an example of a process flow of the information processing apparatus 200.

FIG. 6 schematically shows an example of functional configuration of an information management server 300.

FIG. 7 schematically shows an example of hardware configuration of a computer 1200 that functions as the information processing apparatus 200.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

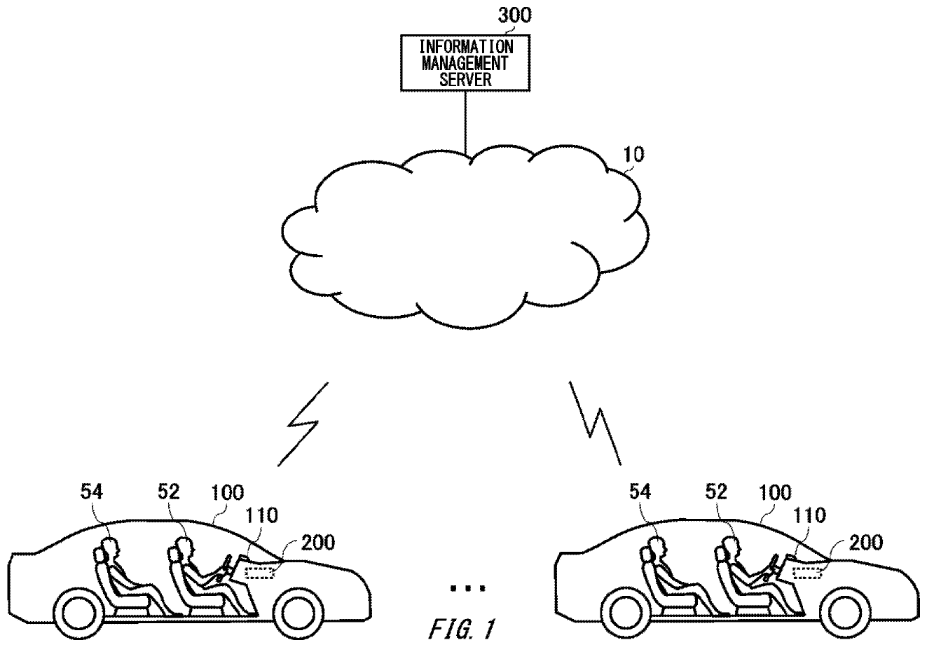

FIG. 1 schematically shows an example of a vehicle 100 according to the present embodiment. The vehicle 100 may be an example of a movable body that moves with a plurality of occupants onboard. The vehicle 100 may include an information processing apparatus 200. The information processing apparatus 200 may have an emotion estimation processing function to estimate the emotion of an occupant of the vehicle 100.

In the present embodiment, if persons in the vehicle 100 are not distinguished, the persons are referred to as occupants, and if a person who is driving and a person who is not driving are distinguished, the former is referred to as a driver 52 and the latter is referred to as a passenger 54. If the vehicle 100 is an automated driving vehicle, the driver 52 may be a person sitting on a driver's seat. The passenger 54 may be a person sitting on a front passenger seat. The passenger 54 may be a person sitting on a backseat.

The information processing apparatus 200 may be capable of performing emotion estimation processing to estimate the emotion of an occupant using an image of the occupant. The information processing apparatus 200 acquires an image of the occupant captured by an image-capturing unit included in the vehicle 100. The image-capturing unit may have one camera 110 capable of capturing images of the entire cabin of the vehicle 100. The information processing apparatus 200 may acquire an image of the driver 52 and an image of the passenger 54 from the camera 110.

The image-capturing unit may have a plurality of cameras 110. The information processing apparatus 200 may acquire, from the plurality of cameras 110, an image of the driver 52 and an image of the passenger 54 that are captured by respective ones of the plurality of cameras 110. For example, the image-capturing unit has a camera 110 capable of capturing images of the driver's seat and front passenger seat and a camera 110 capable of capturing images of the backseat. The image-capturing unit may have a camera 110 capable of capturing images of the driver's seat and a camera 110 capable of capturing images of the front passenger seat. The image-capturing unit may have a plurality of cameras 110 capable of capturing images of respective ones of a plurality of passengers 54 in the backseat.

For example, the information processing apparatus 200 pre-stores an image of the occupant with a neutral facial expression. The neutral facial expression may be a “plain” facial expression. For example, the plain facial expression of an occupant is a facial expression of the occupant when being conscious of nothing. The information processing apparatus 200 may estimate the emotion of the occupant by comparing a face image of the occupant captured by the camera 110 and the image with the neutral facial expression.

For example, the information processing apparatus 200 stores the image of the occupant with the neutral facial expression captured by the camera 110 at initial settings. The information processing apparatus 200 may receive the image of the occupant with the neutral facial expression from another apparatus and store it. For example, the information processing apparatus 200 receives the image of the occupant with the neutral facial expression via short-range wireless communication, such as Bluetooth (registered trademark), from a mobile communication terminal, such as a smartphone, owned by the occupant. Also, for example, the information processing apparatus 200 receives the image of the occupant with the neutral facial expression via a mobile communication network or the like from a management server that manages the image of the occupant with the neutral facial expression.

The information processing apparatus 200 may estimate the emotion of the occupant by using a generic image of the neutral facial expression, rather than using the image of the occupant with the neutral facial expression. The generic image of the neutral facial expression may be an averaged image of the neutral facial expressions of a number of persons. The generic image of the neutral facial expression may be prepared for each attribute such as gender, age and race.

For example, the information processing apparatus 200 pre-stores association data in which the difference from the neutral facial expression is associated with a pattern of human emotions. For example, in the association data, a facial expression with lifted mouth corners relative to the neutral facial expression is associated with a positive emotion, and a facial expression with lowered mouth corners relative to the neutral facial expression is associated with a negative emotion. The association data may further associate a degree of difference from the neutral facial expression and a degree of emotion. For example, the association data associates a facial expression with more lifted mouth corners relative to the neutral facial expression with a higher degree. The information processing apparatus 200 identifies one of the pattern of emotions and the degree of emotion based on the image of the occupant captured by the camera 110, the image with the neutral facial expression and the association data, to provide an estimation result of the emotion of the occupant.

For example, the pattern of human emotions adopted may be a pattern of emotions based on Russell's circumplex model, which expresses human emotions on two axes of “Arousal” and “Valence” and expresses emotion degrees by the distance from the origin. Also, for example, the pattern of emotions adopted may be that based on Plutchik's wheel of emotions, which classifies human emotions into eight basic emotions (joy, trust, fear, surprise, sadness, disgust, anger and anticipation) and advanced emotions each combining two adjacent emotions. Any pattern of emotions may be adopted for the information processing apparatus 200 according to the present embodiment, without being limited to these.

The information processing apparatus 200 may also estimate the emotion of the occupant by, instead of using the image with the neutral facial expression, storing a plurality of face images of the occupant when having respective types of emotions and thereafter comparing face images of the occupant captured by the camera 110 with the stored face images. For example, the information processing apparatus 200 identifies the face image that is the most similar of the stored face images to the face image of the occupant captured by the camera 110, and determines an emotion type corresponding to the identified face image as an estimation result of the emotion type of the occupant. The information processing apparatus 200 may also determine a degree according to the degree of similarity between the face image of the occupant captured by the camera 110 and the most similar face image as an estimation result of the degree of emotion of the occupant.

The information processing apparatus 200 may estimate the emotion of the occupant based on changes in face images of the occupant or the like, instead of using pre-stored images. There are various known techniques for estimating the emotion of a person from a face image of the person, and any of the various techniques may be adopted.

To perform emotion estimation processing by using respective face images of the occupant when having a plurality of types of emotions, it is necessary to acquire and store those face images in advance. Even in the case of performing emotion estimation processing by using the neutral facial expression, for example, it is desirable to analyze how and which parts of the face change relative to the neutral facial expression when the occupant is surprised, and it is desirable to acquire in advance the face image of the occupant when surprised.

However, for example, since the occupant cannot get surprised intentionally, it may be difficult to acquire the face image of the occupant when surprised. The same applies for face images of other emotions, and it may be difficult to acquire the respective face images of the occupant when having a plurality of types of emotions.

The information processing apparatus 200 according to the present embodiment may have a function to collect face images of the occupant when having a particular emotion. For example, the information processing apparatus 200 pre-registers those situations of the vehicle 100 that are expected to make the occupant surprised, such as sudden braking, sudden acceleration, and airbag activation. The information processing apparatus 200 monitors the situation of the vehicle 100, and when the situation of the vehicle 100 matches a registered situation, stores the face image of the occupant captured by the camera 110 at that time in association with the emotion of surprise. This enables efficiently collecting face images of the occupant when the occupant is surprised. Also, the use of the collected face images enables detecting that the occupant is surprised at high accuracy.

The information processing apparatus 200 according to the present embodiment may have a function to improve the convenience of the vehicle 100 for use by the occupant by using the function of detecting that the occupant is surprised. For example, some control operations performed by the vehicle 100 side may make the driver 52 surprised. When detecting that the driver 52 is surprised after such a control operation is performed, the information processing apparatus 200 outputs description information for describing the control operation. When not detecting that the driver 52 is surprised after such a control operation is performed, the information processing apparatus 200 does not output the description information.

As a specific example, the information processing apparatus 200 outputs description information as a sound indicating that “the ABS is activated” when detecting that the driver 52 is surprised after the ABS is operated by the vehicle 100, and does not output the description information when not detecting that the driver 52 is surprised. Thus, if the driver 52 is not used to the ABS, outputting the description information to the driver 52 can relieve the driver 52. On the other hand, if the driver 52 is used to the ABS, this can prevent the driver 52 from feeling annoyed due to the output of the description information to the driver 52.

The information processing apparatus 200 may share the collected face images of the occupant with another vehicle 100 or the like. For example, the information processing apparatus 200 acquires identification information of an occupant in the vehicle 100, and when storing a face image of the occupant and an emotion in association with each other, stores the identification information in association together. The information processing apparatus 200 then sends, to an information management server 300 via a network 10, the identification information, face image and emotion that are stored in association.

For example, the identification information of the occupant is a user ID allocated by the information management server 300. The identification information is capable of identifying the occupant, and may be any information as long as it can identify the occupant, such as the number of a mobile phone owned by the occupant, for example.

The network 10 may be any network. For example, the network 10 may include mobile communication systems such as a 3G (3rd Generation) communication system, an LTE (Long Term Evolution) communication system, and a 5G (5th Generation) communication system. The network 10 may include the Internet, a public wireless LAN (Local Area Network), any dedicated network and the like.

The information management server 300 registers pieces of identification information, face images and emotions collected from a plurality of information processing apparatuses 200. For example, when receiving a request including identification information, and if a face image and emotion associated with the identification information are registered, the information management server 300 sends the face image and emotion to the source of the request. For example, the source of the request is the information processing apparatus 200 of the vehicle 100. For example, when an occupant rides in the vehicle 100 provided with the information processing apparatus 200, the information processing apparatus 200 acquires identification information of the occupant, sends a request including the identification information to the information management server 300, and receives the face image and emotion from the information management server 300. The source of the request may be any apparatus as long as it is an apparatus to perform emotion estimation processing based on a person's face image.

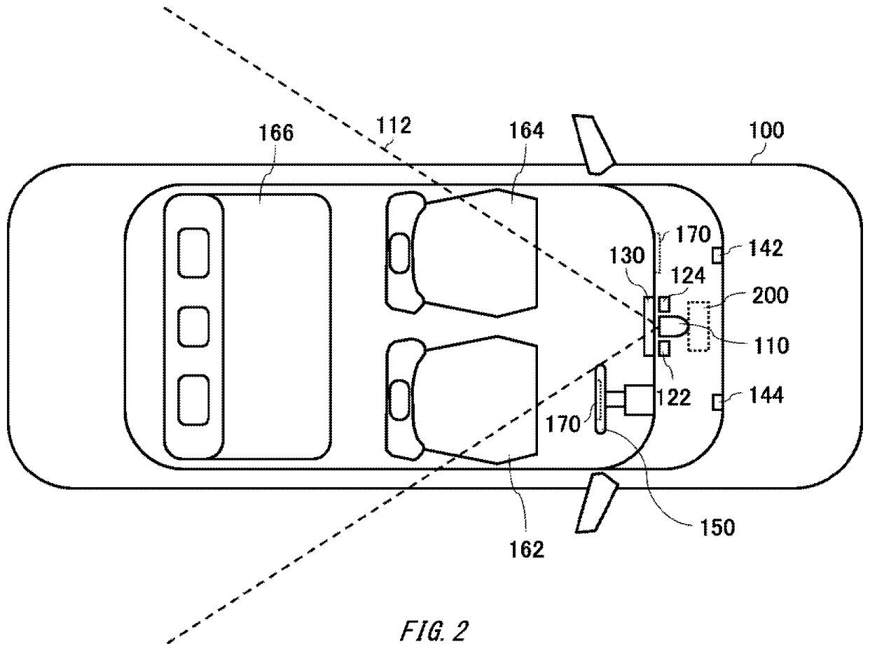

FIG. 2 schematically shows an example of configuration of the vehicle 100. The components shown in FIG. 2 may be a part of a navigation system included in the vehicle 100.

The vehicle 100 includes a camera 110. In the example of FIG. 2, the vehicle 100 includes the camera 110 that is capable of capturing images of all of the driver's seat 162, front passenger seat 164 and backseat 166. As indicated by an angle of view 112 shown in FIG. 2, the camera 110 is capable of capturing images of the occupants on the driver's seat 162, front passenger seat 164 and backseat 166. The arrangement of the camera 110 in FIG. 2 is an example, and the camera 110 may be arranged at any position as long as it can capture images of all of the driver's seat 162, front passenger seat 164 and backseat 166. Note that the vehicle 100 may include a plurality of cameras 110 for capturing respective ones of the driver's seat 162, front passenger seat 164 and backseat 166.

The vehicle 100 may include a microphone 122. FIG. 2 shows an example in which the vehicle 100 includes a microphone 122 that supports all of the driver's seat 162, front passenger seat 164 and backseat 166. The arrangement of the microphone 122 in FIG. 2 is an example, and the microphone 122 may be arranged at any position as long as it can pick up the voices of all the occupants on the driver's seat 162, front passenger seat 164 and backseat 166. The vehicle 100 may include a plurality of microphones 122. For example, the plurality of microphones 122 include a microphone 122 for the driver's seat 162, a microphone 122 for the front passenger seat 164 and a microphone 122 for the backseat 166.

The vehicle 100 includes a speaker 124. FIG. 2 shows an example in which the vehicle 100 includes the speaker 124 that supports all of the driver's seat 162, front passenger seat 164 and backseat 166. The arrangement of the speaker 124 in FIG. 2 is an example, and the speaker 124 may be arranged at any position. The vehicle 100 may include a plurality of speakers 124.

The vehicle 100 includes a display 130. The arrangement of the display 130 in FIG. 2 is an example, and the display 130 may be arranged at any position as long as it can be viewed mainly from the driver's seat 162 and front passenger seat 164. The display 130 may be a touchscreen display. The vehicle 100 may include a plurality of displays 130. For example, the vehicle 100 includes a display 130 for the driver's seat 162 and front passenger seat 164 and a display 130 for the backseat 166.

The vehicle 100 includes a wireless communication antenna 142. The wireless communication antenna 142 may be an antenna for performing communication with an apparatus on the network 10. For example, the vehicle 100 communicates with an apparatus on the network 10 by way of a wireless base station, wireless router and the like in a mobile communication system by using the wireless communication antenna 142. Note that the wireless communication antenna 142 may be an antenna for performing vehicle-to-vehicle communication, vehicle-to-infrastructure communication and the like, and the vehicle 100 may communicate with an apparatus on the network 10 through the vehicle-to-vehicle communication, vehicle-to-infrastructure communication and the like.

The vehicle 100 includes a GPS (Global Positioning System) antenna 144. The GPS antenna 144 receives radio waves for position measurement from GPS satellites. The vehicle 100 may measure the current location of the vehicle 100 using the position-measurement radio waves received by the GPS antenna 144. The vehicle 100 may also use autonomous navigation in combination to measure the current location of the vehicle 100. The vehicle 100 may measure the current location of the vehicle 100 using any known position-measurement technique.

The vehicle 100 may include a sensor (not shown) capable of detecting biological information of the occupant of the vehicle 100. For example, the sensor is arranged at a steering wheel 150, the driver's seat 162, the front passenger seat 164, the backseat 166, or the like to detect biological information, such as heartbeat, pulse rate, sweating, blood pressure and body temperature, of the occupant. The vehicle 100 may include a short-range wireless communication unit communicatively connected to a wearable device worn by the occupant, and may receive, from the wearable device, biological information of the occupant detected by the wearable device. For example, the short-range wireless communication unit is communicatively connected to the wearable device via Bluetooth or the like.

The above-mentioned components may be included in the information processing apparatus 200. The information processing apparatus 200 may be integrated with or separated from a navigation system included in the vehicle 100.

The vehicle 100 includes an airbag 170. The vehicle 100 may include an airbag 170 for the driver's seat 162. The vehicle 100 may also include an airbag 170 for the front passenger seat 164. While FIG. 2 shows an example in which the airbags 170 are arranged in front of the driver's seat 162 and the front passenger seat 164, the vehicle 100 may include additional airbags 170 arranged on a side of the driver's seat 162 and on a side of the front passenger seat 164, for example.

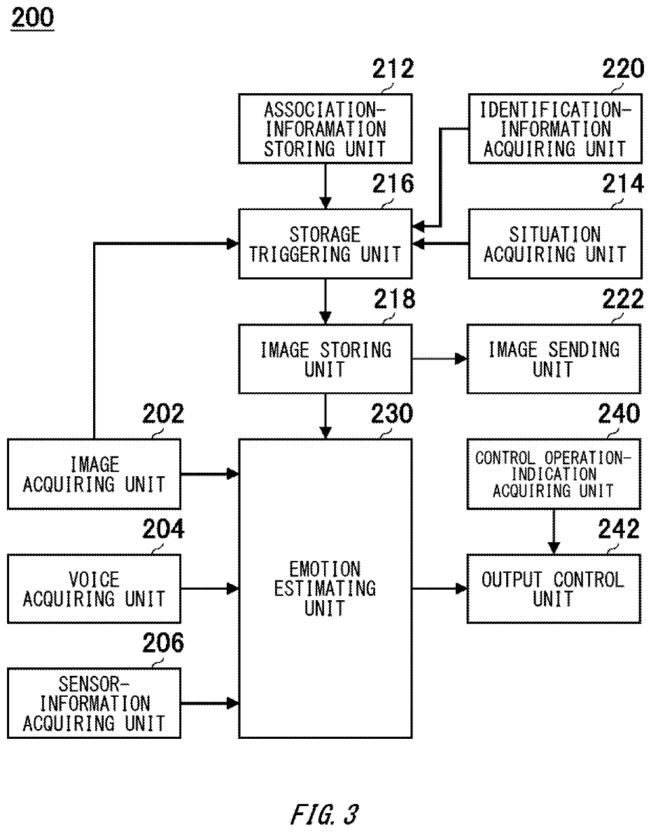

FIG. 3 schematically shows an example of functional configuration of the information processing apparatus 200. The information processing apparatus 200 includes an image acquiring unit 202, a voice acquiring unit 204, a sensor-information acquiring unit 206, an association-information storing unit 212, a situation acquiring unit 214, a storage triggering unit 216, an image storing unit 218, an identification-information acquiring unit 220, an image sending unit 222, an emotion estimating unit 230, a control operation-indication acquiring unit 240 and an output control unit 242. Note that the information processing apparatus 200 may not necessarily include all of these components.

The image acquiring unit 202 acquires an image of an occupant of the vehicle 100. The image acquiring unit 202 acquires an image of the occupant captured by the image-capturing unit of the vehicle 100. The image acquiring unit 202 may continuously acquire images of the occupant captured by the image-capturing unit of the vehicle 100.

The voice acquiring unit 204 acquires a voice of an occupant of the vehicle 100. The voice acquiring unit 204 acquires a voice of the occupant input from the microphone 122 of the vehicle 100. The voice acquiring unit 204 may continuously acquire voices of the occupant from the microphone 122 of the vehicle 100.

The sensor-information acquiring unit 206 acquires biological information of an occupant of the vehicle 100 detected by a sensor. For example, the sensor-information acquiring unit 206 acquires, from a sensor arranged at the steering wheel 150, the driver's seat 162, the front passenger seat 164, the backseat 166, or the like, biological information, such as heartbeat, pulse rate, sweating, blood pressure and body temperature, of the occupant detected by the sensor. Also, for example, the sensor-information acquiring unit 206 acquires, from a wearable device worn by the occupant, biological information, such as heartbeat, pulse rate, sweating, blood pressure and body temperature, of the occupant detected by the wearable device.

The association-information storing unit 212 stores association information in which a plurality of situations of the vehicle 100 are associated with respective emotion types. The association-information storing unit 212 stores association information in which a plurality of situations of the vehicle 100 are associated with respective emotion types that are likely to felt by an occupant of the vehicle 100 when the vehicle 100 is in those situations. For example, in the association information, a sudden braking operation by the automated driving function is associated with the emotion of surprise of an occupant. In the association information, emotion types may be associated differently between the driver 52 and the passenger 54 in accordance with the situation. For example, in the association information, a sudden braking operation by the driver 52 is associated with the emotion of surprise of the passenger 54, but not with the emotion of surprise of the driver 52.

Also, for example, in the association information, a sudden acceleration operation by the automated driving function is associated with the emotion of surprise of an occupant. Also, for example, in the association information, a sudden acceleration operation by the driver 52 is associated with the emotion of surprise of the passenger 54. Also, for example, in the association information, an airbag activation operation is associated with the emotion of surprise of an occupant. Also, for example, in the association information, a situation of the vehicle 100 passing over a regional border, such as a prefectural border, is associated with the emotion of excitement of an occupant.

The situation acquiring unit 214 acquires the situation of the vehicle. For example, the situation acquiring unit 214 acquires, from the navigation system of the vehicle 100, the situation of the vehicle 100 managed by the navigation system. The navigation system of the vehicle 100 may determine the situation of the vehicle 100 based on position information of the vehicle 100, data of roads near the vehicle 100, and the speed, acceleration, steering wheel's operational state, and brakes' operational state of the vehicle 100, and the like. The situation of the vehicle 100 may be determined by the situation acquiring unit 214. The situation acquiring unit 214 may determine the situation of the vehicle 100 using information received from the navigation system of the vehicle 100.

For example, the situation of the vehicle 100 includes information about the driving speed of the vehicle 100. For example, the information about the driving speed of the vehicle 100 includes those indicating normal-speed driving of the vehicle 100, acceleration of the vehicle 100, sudden acceleration of the vehicle 100, sudden braking, sudden stopping of the vehicle 100, and the like. If the vehicle 100 is a motor vehicle capable of automated driving, the situation of the vehicle 100 may include whether the vehicle 100 is in the automated driving mode or in the manual driving mode.

When the situation of the vehicle 100 matches any of a plurality of predetermined situations, the storage triggering unit 216 stores, in the image storing unit 218 in association with a predetermined emotion type, a face image of an occupant of the vehicle 100 captured by the image-capturing unit of the vehicle 100 when the vehicle 100 is in the situation. For example, the plurality of predetermined situations include sudden braking, sudden acceleration, airbag activation and the like, and the predetermined emotion type may be surprise.

When the situation of the vehicle 100 matches any of a plurality of situations included in the association information stored in the association-information storing unit 212, the storage triggering unit 216 may store, in the image storing unit 218 in association with an emotion corresponding to the situation, a face image of an occupant of the vehicle 100 captured by the image-capturing unit of the vehicle 100 when the vehicle 100 is in the situation.

For example, when a sudden braking operation of the vehicle 100 is performed by the driver 52, the storage triggering unit 216 stores, in the image storing unit 218 in association with the emotion of surprise, a face image of the passenger 54 of the vehicle 100 captured by the image-capturing unit when the sudden braking operation is performed. Also, when a sudden braking operation of the vehicle 100 is performed by the automatic braking function, the storage triggering unit 216 stores, in the image storing unit 218 in association with the emotion of surprise, a face image of an occupant of the vehicle 100 captured by the image-capturing unit when the sudden braking operation is performed. When a sudden braking operation is performed by the automatic braking function, it is likely that the driver 52 and the passenger 54 are both surprised. On the other hand, when a sudden braking operation is performed by the driver 52, it is likely that only the passenger 54 is surprised. Thus, the storage triggering unit 216 according to the present embodiment selects the target whose face image is to be stored depending on the entity that performs the sudden braking operation. This can reduce the possibility of storing a face image of the driver 52 when not surprised in association with the emotion of surprise, improving the accuracy of collection of face images.

Also, for example, when a sudden acceleration operation of the vehicle 100 is performed by the driver, the storage triggering unit 216 stores, in the image storing unit 218 in association with the emotion of surprise, a face image of the passenger of the vehicle 100 captured by the image-capturing unit when the sudden acceleration operation is performed. Also, for example, when a sudden acceleration operation of the vehicle 100 is performed by the automated driving function, the storage triggering unit 216 stores, in the image storing unit 218 in association with the emotion of surprise, a face image of an occupant of the vehicle 100 captured by the image-capturing unit when the sudden acceleration operation is performed. When a sudden acceleration operation is performed by the automated driving function, it is likely that the driver 52 and the passenger 54 are both surprised. On the other hand, when a sudden acceleration operation is performed by the driver 52, it is likely that only the passenger 54 is surprised. Thus, the storage triggering unit 216 according to the present embodiment selects the target whose face image is to be stored depending on the entity that performs the sudden acceleration operation. This can reduce the possibility of storing a face image of the driver 52 when not surprised in association with the emotion of surprise, improving the accuracy of collection of face images.

Also, for example, the storage triggering unit 216 stores, in the image storing unit 218 in association with the emotion of surprise, a face image of an occupant of the vehicle 100 captured by the image-capturing unit when an airbag in the vehicle 100 is activated. This enables acquiring a face image of the occupant when surprised at a high probability.

The identification-information acquiring unit 220 acquires identification information of an occupant of the vehicle 100. For example, the identification-information acquiring unit 220 identifies a person by applying a person recognition technique to a face image of the occupant acquired by the image acquiring unit 202, and acquires the identification information of the identified person. Also, for example, the identification-information acquiring unit 220 identifies a person by applying a speaker recognition technique to a voice of the occupant acquired by the voice acquiring unit 204, and acquires the identification information of the identified person. The identification-information acquiring unit 220 may receive the identification information of the occupant from a mobile communication terminal owned by the occupant via short-range wireless communication. When storing a face image of an occupant and an emotion type in association in the image storing unit 218, the storage triggering unit 216 may store the identification information of the occupant in association together in the image storing unit 218.

The image sending unit 222 sends, to the information management server 300, the identification information, face image and emotion type that are stored in association in the image storing unit 218. The image sending unit 222 may send the identification information, face image and emotion type to the information management server 300 via the network 10. This enables sharing a face image associated with an emotion type between a plurality of vehicles 100, contributing to improvement of the accuracy of emotion estimation in all of the plurality of vehicles 100.

The emotion estimating unit 230 estimates the emotion of an occupant by performing emotion estimation processing. The emotion estimating unit 230 may estimate the type and degree of the emotion of the occupant by performing the emotion estimation processing. The emotion estimating unit 230 may perform the emotion estimation processing by using a face image of the occupant acquired by the image acquiring unit 202. The emotion estimating unit 230 may perform the emotion estimation processing by using a face image of the occupant and an emotion type that are stored in association in the image storing unit 218.

The emotion estimating unit 230 may be capable of performing the emotion estimation processing by using a voice of the occupant acquired by the voice acquiring unit 204. For example, the emotion estimating unit 230 performs the emotion estimation processing based on a feature of the voice itself. Examples of features of a voice itself can include the volume, tone, spectrum, fundamental frequency and the like of the voice. The emotion estimating unit 230 may perform the emotion estimation processing based on a text string obtained from speech recognition on a voice. The emotion estimating unit 230 may also perform the emotion estimation processing based on both of a feature of a voice itself and a text string obtained from speech recognition on the voice. If the vehicle 100 includes a plurality of microphones for picking up respective voices of a plurality of occupants, the emotion estimating unit 230 may identify the speaker based on the difference between the microphones. If a single microphone is used to pick up voices of a plurality of occupants, the emotion estimating unit 230 may identify the speaker by using a known speaker identification function. Examples of the known speaker identification function include a method using voice features, a method of determining from the direction of capturing the voice, and the like. There are various known techniques for estimating the emotion of a person from a voice of the person, and any of the various techniques may be adopted for the emotion estimating unit 230.

The emotion estimating unit 230 may also be capable of performing the emotion estimation processing by using a plurality of types of biological information acquired by the sensor-information acquiring unit 206. For example, the emotion estimating unit 230 performs the emotion estimation processing by using the heartbeat, pulse rate, sweating, blood pressure, body temperature and the like of the occupant. There are various known techniques for estimating the emotion of a person from the heartbeat, pulse rate, sweating, blood pressure, body temperature and the like of the person, and any of the various techniques may be adopted for the information processing apparatus 200.

The control operation-indication acquiring unit 240 acquires an indication of a control operation performed by the vehicle 100. The output control unit 242 performs control to output description information about a control operation when an indication of the control operation acquired by the control operation-indication acquiring unit 240 indicates a predetermined control operation and the emotion of the occupant estimated by the emotion estimating unit 230 when the control operation is performed is surprise. The output control unit 242 may determine whether the emotion of the driver 52 is surprise, and if the emotion of the driver 52 is surprise, control to output description information about the control operation. Also, the output control unit 242 may determine whether the emotion of each occupant is surprise, and if the emotion of any one occupant is surprise, control to output description information about the control operation. Also, the output control unit 242 may control to output description information about the control operation if the emotions of all occupants are surprise.

The predetermined control operation may be a control operation pre-registered as a control operation that possibly makes the occupant of the vehicle 100 surprised when the vehicle 100 performs the predetermined control operation. For example, the predetermined control operation is an ABS (Antilock Brake System) operation. Also, for example, the predetermined control operation is an ESC (Electric Stability Control) operation. The ESC may have different designations, such as VSA (Vehicle Stability Assist), for example. In the present embodiment, the ESC may include all of those designations.

For example, the predetermined control operation is a control operation for at least one of collision avoidance and damage mitigation. An example of such a control operation is what is called collision damage mitigation braking. The collision damage mitigation braking system may have different designations, such as CMBS (Collision Mitigation Brake System), for example. In the present embodiment, the control operation for at least one of collision avoidance and damage mitigation may include all of those designations.

The predetermined control operation may also be a hill-start assist operation, a seatbelt reminder operation, an automatic locking operation, an alarming operation, a speed limiter operation, a start-stop operation, and the like.

Description information is associated with each predetermined control operation. A single piece of description information may be associated with each predetermined control operation. A plurality of pieces of description information with different degrees of detail may be associated with each predetermined control operation.

For example, description information indicating that “the ABS is activated” is associated with the ABS operation. Also, for example, description information indicating that “the ABS is activated” and more detailed description information indicating that “the ABS is activated, which is a system for detecting the vehicle speed and the wheel rotation speed and automatically controlling the brakes so that the wheels are not locked when applying the brakes” are associated with the ABS operation.

For example, the output control unit 242 controls the speaker 124 to output the description information by means of sound. Also, for example, the output control unit 242 controls the display 130 to output the description information by means of display. The output control unit 242 does not perform control to output the description information when the emotion of the occupant estimated by the emotion estimating unit 230 when the control operation is performed is not surprise. That is, the description information is not output when the emotion of the occupant estimated by the emotion estimating unit 230 when the control operation is performed is not surprise.

The output control unit 242 may perform control to output description information about a control operation when an indication of the control operation acquired by the control operation-indication acquiring unit 240 indicates a predetermined control operation, the emotion of the occupant estimated by the emotion estimating unit 230 when the control operation is performed is surprise, and, in addition, the degree of emotion of surprise is higher than a predetermined threshold. In this case, the output control unit 242 does not perform control to output the description information when the indication of the control operation acquired by the control operation-indication acquiring unit 240 indicates a predetermined control operation, and the emotion of the occupant estimated by the emotion estimating unit 230 when the control operation is performed is surprise, but the degree of emotion of surprise is lower than a predetermined threshold. This can reduce the possibility of making the occupant feel annoyed by outputting the description information when the occupant is very little surprised.

The output control unit 242 may perform control to output first description information about a control operation when an indication of the control operation acquired by the control operation-indication acquiring unit 240 indicates a predetermined control operation and the emotion of the occupant estimated by the emotion estimating unit 230 when the control operation is performed is surprise, and perform control to output second information that is more detailed than the first description information when an emotion of the occupant estimated by the emotion estimating unit 230 after the first description information is output is confusion. Thus, when the occupant cannot understand the output description information, outputting more detailed description information can relieve the occupant.

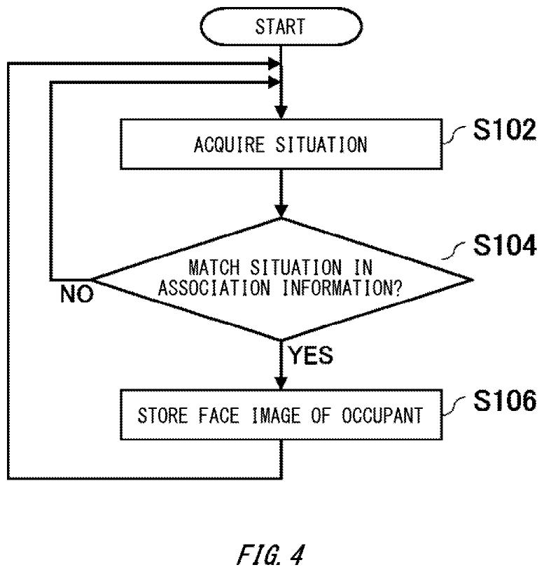

FIG. 4 schematically shows an example of a process flow of the information processing apparatus 200. FIG. 4 illustrates a process flow of the information processing apparatus 200 for storing face images of an occupant in accordance with the situation while monitoring the situation of the vehicle 100.

In Step (a Step may be abbreviated as S) 102, the situation acquiring unit 214 acquires the situation of the vehicle 100. In S104, the storage triggering unit 216 determines whether the situation of the vehicle 100 acquired in S102 matches any of a plurality of situations included in the association information stored in the association-information storing unit 212. If determined as matching, the process proceeds to S106, and if determined as not matching, the process returns to S102.

In S106, the storage triggering unit 216 stores, in the image storing unit 218 in association with an emotion type corresponding to the situation acquired in S102, a face image of an occupant of the vehicle 100 captured by the image-capturing unit of the vehicle 100 when the vehicle 100 is in the situation. The process then returns to S102.

The process shown in FIG. 4 may continue until the monitoring of the situation of the vehicle 100 is stopped. For example, the information processing apparatus 200 ends the process shown in FIG. 4 such as when instructed from an occupant to stop it, when the engine of the vehicle 100 is stopped, and when the vehicle 100 is powered off.

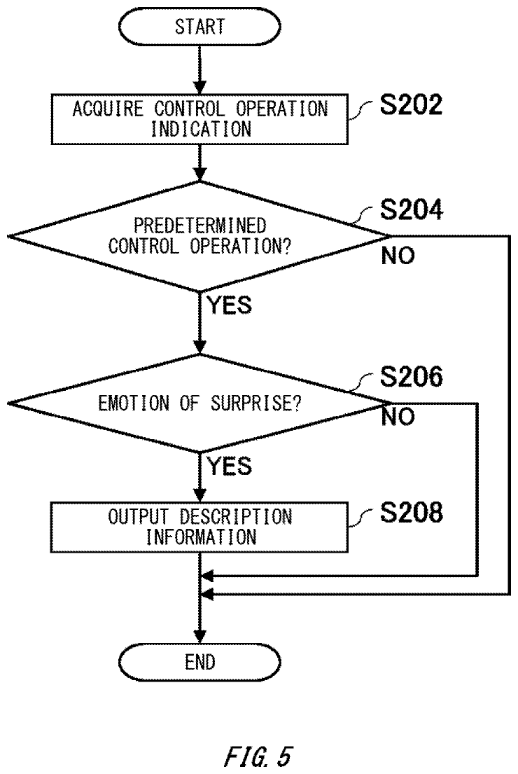

FIG. 5 schematically shows an example of a process flow of the information processing apparatus 200. FIG. 5 illustrates a process performed by the output control unit 242 when the control operation-indication acquiring unit 240 acquires an indication of a control operation performed by the vehicle 100.

In S202, the control operation-indication acquiring unit 240 acquires an indication of a control operation performed by the vehicle 100. In S204, the output control unit 242 determines whether the indication of the control operation acquired in S202 indicates a predetermined control operation. When determined as indicating the predetermined control operation, the process proceeds to S206, and when determined as not indicating the predetermined control operation, the process ends.

In S206, the output control unit 242 determines whether the emotion of an occupant estimated by the emotion estimating unit 230 when the control operation acquired in S202 is performed is surprise. When determined as surprise, the process proceeds to S208, and when not determined as surprise, the process proceeds to S208. In S208, the output control unit 242 performs control to output description information corresponding to the control operation acquired in S202. The process then ends.

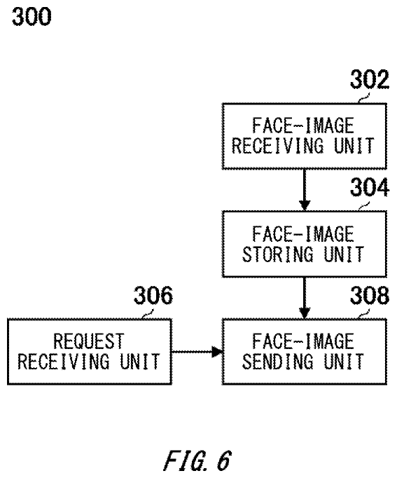

FIG. 6 schematically shows an example of functional configuration of the information management server 300. The information management server 300 includes a face-image receiving unit 302, a face-image storing unit 304, a request receiving unit 306 and a face-image sending unit 308.

The face-image receiving unit 302 receives, from each of a plurality of information processing apparatuses 200 via the network 10, a face image associated with identification information and an emotion type. The face-image storing unit 304 stores the face image received by the face-image receiving unit 302.

The request receiving unit 306 receives a request for the face image including the identification information. When the request receiving unit 306 receives the request, the face-image sending unit 308 determines whether the face image associated with the identification information included in the request is stored in the face-image storing unit 304, and if so, sends the face image along with the associated emotion type to the source of the request.

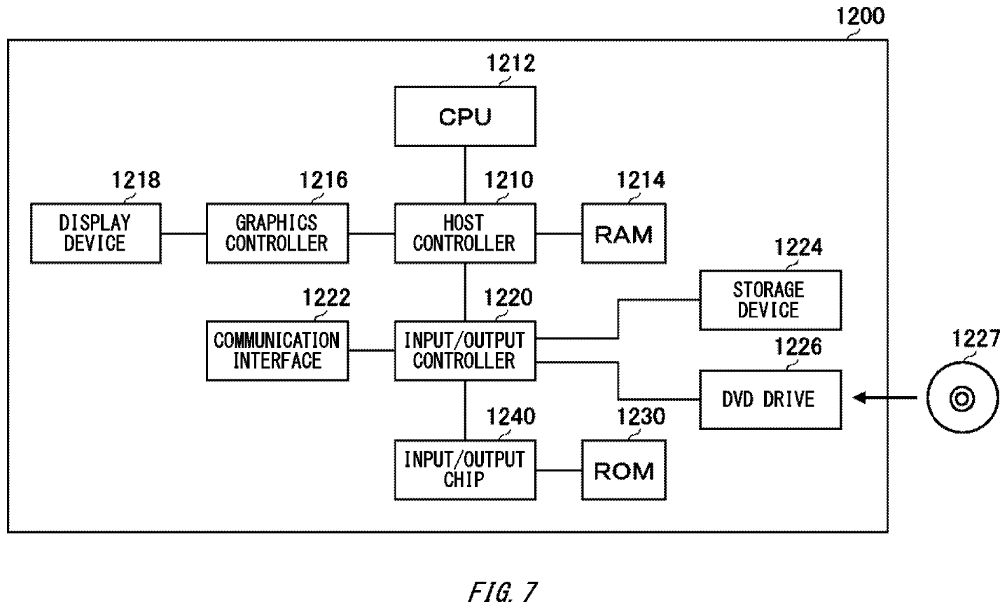

FIG. 7 schematically shows an example of hardware configuration of a computer 1200 that functions as the information processing apparatus 200. A program that is installed in the computer 1200 can cause the computer 1200 to function as one or more units of apparatuses of the above embodiments or perform operations associated with the apparatuses of the above embodiments or the one or more units, and/or cause the computer 1200 to perform processes of the above embodiments or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage device 1224, a DVD drive 1226 and an IC card drive, which are connected to the host controller 1210 via an input/output controller 1220. The DVD drive 1226 may be a DVD-ROM drive, a DVD-RAM drive, etc. The storage device 1224 may be a hard disk drive, a solid-state drive, etc. The computer 1200 also includes input/output units such as a ROM 1230 and a touch panel, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on a display device 1218. The computer 1200 may not include the display device 1218, in which case the graphics controller 1216 causes the image data to be displayed on an external display device.

The communication interface 1222 communicates with other electronic devices via a wireless communication network. The storage device 1224 stores programs and data used by the CPU 1212 within the computer 1200. The DVD drive 1226 reads the programs or the data from the DVD-ROM 1227 or the like, and provides the storage device 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port and the like to the input/output controller 1220.

A program is provided by computer readable storage media such as the DVD-ROM 1227 or the IC card. The program is read from the computer readable storage media, installed into the storage device 1224, RAM 1214, or ROM 1230, which are also examples of computer readable storage media, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffer region provided in a recording medium such as the RAM 1214, the storage device 1224, the DVD-ROM 1227, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive 1226 (DVD-ROM 1227), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable storage media on or near the computer 1200. In addition, a recording medium such as a hard disk or a RAM provided in a server system connected to a dedicated communication network or the Internet can be used as the computer readable storage media, thereby providing the program to the computer 1200 via the network.

Blocks in flowcharts and block diagrams in the above embodiments may represent steps of processes in which operations are performed or units of apparatuses responsible for performing operations. Certain steps and units may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, and memory elements, such as field-programmable gate arrays (FPGA), programmable logic arrays (PLA), etc.

Computer-readable storage media may include any tangible device that can store instructions for execution by a suitable device, such that the computer-readable storage medium having instructions stored therein comprises an article of manufacture including instructions which can be executed to create means for performing operations specified in the flowcharts or block diagrams. Examples of computer-readable storage media may include an electronic storage medium, a magnetic storage medium, an optical storage medium, an electromagnetic storage medium, a semiconductor storage medium, etc. More specific examples of computer-readable storage media may include a floppy disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY® disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA, C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., so that the processor of the general purpose computer, special purpose computer, or other programmable data processing apparatus, or the programmable circuitry executes the computer-readable instructions to create means for performing operations specified in the flowcharts or block diagrams. Examples of processors include computer processors, processing units, microprocessors, digital signal processors, controllers, microcontrollers, etc.

The vehicle 100 has been described as an example of the movable body in the above embodiments, but the movable body is not limited thereto. For example, the movable body may be a train, an airplane, a marine vessel, or the like. The association-information storing unit 212 may store association information in which a plurality of situations of a movable body are associated with respective emotion types in consideration of the type of the movable body. Also, a control operation that possibly makes an occupant of the movable body surprised when the movable body performs the control operation may be registered as a predetermined control operation.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: network, 52: driver, 54: passenger, 100: vehicle, 110: camera, 112: angle of view, 122: microphone, 124: speaker, 130: display, 142: wireless communication antenna, 144: GPS antenna, 150: steering wheel, 162: driver's seat, 164: front passenger seat, 166: backseat, 170: airbag, 200: information processing apparatus, 202: image acquiring unit, 204: voice acquiring unit, 206: sensor-information acquiring unit, 212: association-information storing unit, 214: situation acquiring unit, 216: storage triggering unit, 218: image storing unit, 220: identification-information acquiring unit, 222: image sending unit, 230: emotion estimating unit, 240: control operation-indication acquiring unit, 242: output control unit, 300: information management server, 302: face-image receiving unit, 304: face-image storing unit, 306: request receiving unit, 308: face-image sending unit, 1200: computer, 1210: host controller, 1212: CPU, 1214: RAM, 1216: graphics controller, 1218: display device, 1220: input/output controller, 1222: communication interface, 1224: storage, 1226: DVD drive, 1227: DVD-ROM, 1230: ROM, 1240: input/output chip

What is claimed is:

1. An information processing apparatus comprising:
an emotion estimating unit configured to estimate an emotion of an occupant of a movable body based on an image of the occupant of the movable body captured by an image-capturing unit provided in the movable body; and
an output control unit configured to perform control to output description information about a control operation performed by the movable body when the control operation performed by the movable body is a predetermined control operation and an emotion of the occupant estimated by the emotion estimating unit when the control operation is performed is surprise.

2. The information processing apparatus according to claim 1, wherein the output control unit does not perform control to output the description information when the emotion of the occupant estimated by the emotion estimating unit when the control operation is performed is not surprise.

3. The information processing apparatus according to claim 1, wherein
the emotion estimating unit estimates a type and degree of an emotion of the occupant, and
the output control unit performs control to output description information about a control operation performed by the movable body when the control operation performed by the movable body is the predetermined control operation, the emotion of the occupant estimated by the emotion estimating unit when the control operation is performed is surprise, and the degree of the surprise is greater than a predetermined threshold.

4. The information processing apparatus according to claim 3, wherein the output control unit does not perform control to output the description information when the emotion of the occupant estimated by the emotion estimating unit when the control operation is performed is surprise and the degree of the surprise is less than the predetermined threshold.

5. The information processing apparatus according to claim 1, wherein the output control unit performs control to output first description information about a control operation performed by the movable body when the control operation performed by the movable body is the predetermined control operation and the emotion of the occupant estimated by the emotion estimating unit when the control operation is performed is surprise, and performs control to output second description information that is more detailed than the first description information when an emotion of the occupant estimated by the emotion estimating unit after the first description information is output is confusion.

6. The information processing apparatus according to claim 1, wherein the predetermined control operation is a control operation pre-registered as a control operation that possibly makes the occupant of the movable body surprised when the movable body performs the predetermined control operation.

7. The information processing apparatus according to claim 6, wherein
the movable body is a motor vehicle, and
the predetermined control operation is an ABS (Antilock Brake System) operation.

8. The information processing apparatus according to claim 6, wherein
the movable body is a motor vehicle, and
the predetermined control operation is an ESC (Electric Stability Control) operation.

9. The information processing apparatus according to claim 6, wherein
the movable body is a motor vehicle, and
the predetermined control operation is a control operation for at least one of collision avoidance and damage mitigation.

10. The information processing apparatus according to claim 1, wherein
the movable body is a motor vehicle; and
the output control unit performs control to output the description information about the control operation performed by the movable body when the control operation performed by the movable body is the predetermined control operation and an emotion of a driver of the movable body estimated by the emotion estimating unit when the control operation is performed is surprise.

11. The information processing apparatus according to claim 1, wherein
the movable body is capable of accommodating a plurality of occupants, and
the output control unit performs control to output the description information about the control operation performed by the movable body when the control operation performed by the movable body is a predetermined control operation and emotions of all of the occupants of the movable body estimated by the emotion estimating unit when the control operation is performed are surprise.

12. A non-transitory computer-readable storage medium having stored thereon a program that causes a computer to function as:
an emotion estimating unit configured to estimate an emotion of an occupant of a movable body based on an image of the occupant of the movable body captured by an image-capturing unit provided in the movable body; and
an output control unit configured to perform control to output description information about a control operation performed by the movable body when the control operation performed by the movable body is a predetermined control operation and an emotion of the occupant estimated by the emotion estimating unit when the control operation is performed is surprise.
